(19) United States
(12) Patent Application Publication
(10) Pub. No.: US 2024/0109796 A1
(43) Pub. Date: Apr. 4, 2024

(54) WATER TREATMENT UNIT

(71) Applicant: Arvia Technology Limited, Runcorn, Cheshire (GB)

(72) Inventors: Mikael Khan, Runcorn, Cheshire (GB); Akinlabi Adeyemi, Runcorn, Cheshire (GB); Nigel Brown, Runcorn, Cheshire (GB)

(21) Appl. No.: 17/768,749

(22) PCT Filed: Oct. 14, 2020
(86) PCT No.: PCT/EP2020/078869

§ 371 Date: Apr. 13, 2022

(30) Foreign Application Priority Data
Oct. 16, 2019 (GB) 1914956.6

(51) Int. Cl. C02F 1/467; C02F 1/28

(52) U.S. Cl. CPC C02F 1/4672; C02F 1/283; C02F 2001/46152

(57) ABSTRACT

There is provided a modular water treatment unit for a water treatment system comprising two or more ribs arranged to form at least part of a container and one or more separators, said one or more separators disposed between adjacent ribs, as well as a rib therefor. Also described is a water treatment system comprising a tank with an inlet for supplying contaminated water, one or more modular water treatment units located within the tank, said water treatment units comprising one or more electrodes and an electricity supply operably connected to the electrodes. Also provided are a method of constructing a modular water treatment unit for a water treatment system and a method of operating a water treatment unit.

### FIELD OF INVENTION

The present invention relates to a water treatment unit, a system comprising a water treatment unit, a method of constructing a water treatment unit and a method of operating a water treatment unit.

### BACKGROUND

It is known to treat contaminated water through a number of methodologies, including electrochemical treatment in which a current is passed through contaminated water to induce reactions which lead to the removal of the contaminants from the water.

Electrochemical oxidation systems used for the treatment of water typically suffer from the fact that water has a low conductivity which results in a high cell voltage resulting in a high energy, high cost process. Additionally, direct electrochemical oxidation only occurs when the contaminant contacts the electrode, meaning that these systems are very mass transport limited when used for the treatment of low and trace contaminant concentrations. This piecemeal oxidation results in the formation of breakdown products, which can sometimes be more toxic than the initial pollutants. To address these issues the electrode-electrode gap is made as narrow as possible, often 1-5 mm or less. This reduces the cell voltages, particularly when high flow rates are used within the system to create turbulence. However the low residence time and the formation of breakdown products means that the system will recirculate the effluent to be treated many times before the discharge consent is achieved. The small cell gap results in the need for many cells to be used within the system to treat higher flows, usually assembled in series. This results in a high voltage across the combined cells giving a need to protect operators from electric shocks. In addition, the high flow rates through the cells is achieved through high pressure pumping meaning robust cells are required with the attendant costs. Electrochemical systems also require the cells to be electrically isolated from each other except through the proposed electrical pathway, proving a requirement for high levels of tolerance within the machining processes giving high cell costs.

Whilst traditional electrochemical systems for treating water have many benefits the issues raised above demonstrate that there is a need to address the sealing and short-circuiting issues, which result in high costs.

An alternative approach is to use a highly conducting material between the electrodes that can act as an adsorbent to concentrate the pollutants as well as acting as a three-dimensional electrode. The high conductivity results in a low cell voltage giving a low energy, low cost system with the concentration of organics on the adsorbent surface eliminating the issues with mass transport. By using a bed of particles, a low flow rate can be used to give a single pass system. However, the highly conducting material increases the risk of a short circuit and scale up still requires many cells to be assembled in series.

The present invention aims to address at least one of the problems identified above.

### SUMMARY OF INVENTION

A first aspect of the present invention relates to a modular water treatment unit for a water treatment system comprising: two or more ribs arranged to form at least part of a container and one or more separators, said one or more separators disposed between adjacent ribs.

According to a second aspect of the present invention, there is provided a rib for use in the water treatment system according to the first, third, fourth, or fifth aspects of the present invention.

The construction of the unit from modular parts permits simple construction of units of any desired size to suit the system that is being designed. The use of ribs to form at least a portion of the container means that the size of the container can be readily adjusted as required by altering the number of ribs which comprise the unit. For example, a very small unit may only comprise two ribs, whereas a large unit may comprise 20 or more ribs. In this way, a unit comprising two ribs may have a single membrane which is located at the interface of the two ribs, whereas a unit comprising, for example, four ribs, may comprise one, two, or three separators.

The or each separator may be positioned between the opposing faces of adjacent ribs (i.e. in the interfacial area) such that it is held in position between the ribs. There is preferably a separator disposed between each set of ribs, although it is also contemplated that in some cases, there may be no separator disposed between certain pairs of ribs. This may be desirable where the volume of each zone or compartment between neighbouring membranes is preferably larger than would be the cases if a separator were disposed between each pair of ribs.

There may be a gasket or other sealing means between ribs in order to prevent leakage of liquids between the ribs, thereby preventing short-circuiting. The sealing means may comprise, for example, silicone. The ribs may be configured to provide a leak-proof seal without the presence of a gasket or other sealing means. The ribs may be glued, solvent cemented, or welded together, and/or may be clamped together. This eliminates the potential of leaking and/or of short circuiting. Alternatively or additionally, the ribs may be mechanically attached together. For example, the ribs may comprise complementary mating portions which engage with one or more adjacent ribs. The mating portions may comprise complementary male and female mating portions. Such mating portions may provide greater structural strength and/or provide a serpentine seal to further reduce the likelihood of leakage through the join between adjacent ribs. In addition, the membrane may be disposed between the mating portions to provide a greater contact area between the ribs and the membrane and thereby make it more difficult for the membrane to be pulled out from between the ribs.

The at least one separator may be a membrane, optionally an ion-exchange membrane. The separator may be semi-permeable and/or porous, or operate through the transfer of ions using an ion-exchange membrane such as Nafion™. The one or more separators divide the treatment volume into separate compartments. The edges of each separator may terminate between the adjacent ribs it is disposed between such that a portion of the interfacial area does not contain the separator. Alternatively, the separator may extend throughout, or even beyond, the interfacial area. The one or more separator is preferably non-electrically conductive. The separator may allow the passage of ions therethrough, but inhibit or prevent the passage of water. Suitable separator materials include any non-conductive materials which allow the passage of ions therethrough but inhibit or prevent the passage of water and/or contaminants therethrough.

The ribs may be hollow. In other words, each rib may define an internal volume that is free of material. The ribs may be tubular (i.e. have open ends as well as being hollow). This reduces the weight of each rib and of the overall modular water treatment unit. This also reduces the quantity of material required, increasing manufacturing efficiency. The hollow ribs also allow the structure of the container to provide passages through which water can be passed therefore reducing or eliminating the need to provide additional plumbing. This simplifies the construction of the container and decreases costs. The hollow rib section may provide the mechanism for the distribution of flow into the cell.

The ribs may form a base and side walls of the container. This removes the burden of fitting additional components to form the container. In small scale systems the ribs can act as the flow distributor, as well as the container itself.

The ribs may be substantially U-shaped. Such a shape produces a container with an open top and constant cross-sectional area, allowing the construction of units of arbitrary length simply by altering the number of ribs in the unit. In addition, the container formed from U-shaped ribs may have a flat base, allowing it to be free-standing when placed on a level surface. As such, the ribs may comprise substantially parallel arms which extend substantially vertically and a substantially horizontal base connecting the two arms. Each rib may comprise a one-piece, preferably continuous, tube or may comprise one or more sections joined together. The container may have an open top, permitting easy access to the containers internal volume for the addition or removal of materials (e.g. contaminated water, treated water, adsorbents, off-gases), inspection, maintenance and repair. The ribs are preferably self-supporting such that they are able to retain liquid within the water treatment unit without external support. Of course, this does not exclude external support being provided, if desired.

By ensuring the ribs are hydraulically connected, a single feed into one of the ribs will be distributed throughout the ribs and allowed to flow into the bottom of the cell. The ribs may be hydraulically/fluidly connected via openings which allow fluid communication between adjacent ribs. Such connections can be made before, during, or after the ribs are joined.

The one or more separators preferably extend between the arms and down to the base. The one or more separators may extend part way up the arms, all the way to the top of the arms, or may even extend above the top of the arms. In this way, the membranes separate the unit into compartments. The one or more separators therefore prevent any conductive carbon-based adsorbent material contained within the compartments from passing into neighbouring compartments, other than by passing over the one or more separators. By sealing the compartments except at the top, the possibility of electrical connection between the cells is eliminated, eliminating the potential for short-circuiting and leaking.

Of course, ribs of other shapes may be used to produce modular water treatment units. In general terms, each rib is elongate and possesses at least one curve or bend along its length. This ensures that, once arranged face-to-face (with the long faces of neighbouring ribs in opposition to one another), a volume is defined within the at least one curve or bend (i.e. the container). A mixture of ribs may be used to produce a container with a variable cross-section along its length. The use of a varying cross-section permits the construction of units of any desired shape. The ribs may comprise two substantially 90 degree bends in order to form the U-shape. It will be appreciated that bends of greater or less than 90 degrees are also contemplated as long as the bends define a volume for containing water. There may be more than two bends.

The ribs may be configured to engage with adjacent ribs to form a fluid-tight seal. This permits the container to be placed in direct contact with fluids (e.g. contaminated water) while maintaining separation between fluids within the container and fluids outside the container.

In some embodiments, the engageable ribs form a loop, producing a container suitable for immersion in liquids. The container may be provided with a lid to enclose the internal volume defined by the ribs and the lid. The optional lid may be sealed or may be unsealed.

The ribs may comprise plastic. Plastics are well-known for use in electrochemical water systems due to their corrosion resistance, good strength to weight ratio, and their being electrical insulators. Plastics are particularly well-suited to the modular water treatment unit of the present invention due to their easily processible nature making them suitable for mass-manufacturing methods. Other materials may be used if appropriate. Other materials, such as aluminium, may be used, although additional electrical insulation would need to be provided to prevent short circuiting and hazards to operators. Plastic may be easily extruded to form the required shape of the ribs on site which means that the component materials can be transported in substantially straight lengths in order to maximise the amount of materials which can be transported in a given volume. This is particularly advantageous over transporting unitary containers as these may occupy a large volume within the transportation means.

The ribs may comprise box-section, preferably plastic box-section. This material is widely available and a range of existing tooling may be used to manufacture such ribs, reducing tooling costs and complexity. The box-section may have any cross-sectional shape, although square or rectangular cross-sections are preferred as these provide flat mating surfaces between adjacent ribs.

The ribs may include a recess to accommodate the one or more membranes. This separates the interfacial area into an area in which the membrane is held and an area in which adjacent ribs are in direct contact. Such a recess prevents bowing of the ribs which may occur should the membrane extend partially into the interfacial area. The recess is of a sufficient depth and width to hold the membrane firmly without interfering with the contact of the ribs. It will be appreciated that even with a recess, the cross-section of the ribs may still be described as square or rectangular as these shapes define the general cross-sectional shape of the ribs notwithstanding the recess.

The ribs may be configured to permit fluid communication into a treatment volume defined by the container. Contaminated water must be able to enter the treatment volume in order to be treated. By providing means for a controlled flow of contaminated water into the treatment volume through the walls of the container, the need to provide additional equipment (e.g. piping) to effect such a flow is obviated, thereby simplifying the modular water treatment unit. In addition, since the liquid to be treated is provided via the hollow ribs, there is a more even flow distribution into the unit so there is more even distribution of the contaminated water.

The fluid communication into the treatment volume may be via internal volumes of the ribs. This may also require at least one of the ribs to include openings in a surface that contacts the treatment volume. Optionally, openings may be provided in one or more surfaces that contact the external volume. Such a flow would effectively use the rib as a conduit. This advantageously introduces the contaminated water to a particular location within the treatment volume, such as the base of the treatment volume, by siting the openings at selected locations and ensures that the introduction is at a desired rate, by selecting particular opening sizes. In embodiments wherein fluid is directly introduced into the ribs, one or more outlets may be included in the faces of the ribs that form the exterior surface of the modular unit to act as a high level overflow. An opening at the top of the ribs may serve as a high level overflow. By including a high level overflow on one or more of the hydraulically connected ribs, a maximum differential head between the influent level within the ribs and the treated effluent level within the treatment volume is obtained which will ensure a controlled flow into the treatment zone. This will ensure that the residence time of the contaminated water is sufficient for treatment and prevents the entrainment of any particulates (eg the conductive, adsorbent material) in the flow during use.

The differential head required to drive the contaminated water through the system is low (although it depends on the particle size, depth of particles, required flow rate etc.), typically the order of 1-15 cm. This head can often be available on site and eliminates the need for pumping as gravity can provide the necessary driving pressure.

The ribs may have through-holes permitting fluid communication between the treatment volume and the external volume. Such through-holes extend directly through the ribs from the surface in contact with the external volume to the surface in contact with the treatment volume. It should be noted that these holes can be off-set, with those in connection to the inner treatment zone being at the bottom of the ribs whilst those in connection to the outside volume being at higher location on the vertical portions of the ribs. The benefit of putting these holes higher in the ribs means that the external volume can act as a settlement zone which minimises the entry of solid particles that may be present in the contaminated water into the bed.

The one or more membranes may be non-conductive. By being an electrical insulator, the membrane prevents short-circuiting of the electrical circuit during operation of the modular water treatment unit. This also forces electrons to pass out of any conductive absorbent material within the unit and into the water before passing through the one or more membranes/separators and then back into any conductive adsorbent material in the neighbouring compartment. The passage of electrons into and out of the water induces the destruction of contaminants, through oxidation or reduction (note polymerization or precipitation may also occur). The destruction may be the result of electrical (direct electrochemical treatment) and/or chemical reactions (indirect electrochemical treatment) which cause the breakdown of the contaminants. These may include, for example, direct electron transfer and changes in pH of the surrounding liquid.

The modular water treatment unit may comprise at least two electrodes at least partially contained within the container, preferably wherein the electrodes are operably connected to a power supply. Two electrodes are required to set up the electrical circuit required to electrochemically treat water held in the container. More electrodes may be used if required. The electrodes may be connected to a controller. The controller may be configured to selectively adjust the voltage, current, and of polarity of the electrical power provided to the electrodes. The unit may be operated unidirectionally, namely where current is passed in a single direction, or bidirectionally, where the direction of the current is periodically reversed. The current may be reversed in order to remove any scale or build-up on one or more of the electrodes. The current and or voltage may be adjusted to ensure that there is sufficient electrical energy being provided to result in the required level of decontamination or treatment of the water.

The modular water treatment unit may comprise additional apparatus for the delivery of air to the treatment volume. Such apparatus may comprise additional tubing, piping and/or a bubbler. In embodiments wherein the ribs are hollow, it may comprise a connection suitable for connecting an air supply to the internal volume of the ribs and openings for the air to be conveyed to the treatment zone. Said openings may be the same openings as those permitting fluid communication between the external volume and the treatment volume. Preferably, the air is introduced to the bottom of the treatment volume, so that the air passes upward through any particular material and fluid located in the treatment volume. It has been surprisingly found that small pockets of gas may form on the adsorbent material during operation of the treatment unit. These gases may comprise hydrogen formed via the breakdown of water (within the cathodic zones) as well as carbon dioxide/monoxide, chlorine and/or oxygen formed by the oxidation of organic contaminants and water within the anodic zones. The exact composition of the gases is not of particular importance, but the effect is that the contaminated water is unable to interact with the adsorbent material efficiently and so any contaminants within the water are not absorbed onto the surface of the adsorbent material. As most of the destruction of contaminants occurs on the surface of the adsorbent material, if adsorption of the contaminant onto the adsorbent material is prevented, the treatment will slow or stop. In addition it has been found that the presence of these bubbles within the system hinders the flow through the bed, reducing the flow rate. Contrary to expectations, it has been surprisingly found that the addition of more gas to the system serves to remove the gas bubbles formed which interfere with treatment. In addition, the addition of more gas has been found to reduce channelling, which is where channels form in the adsorbent material through which liquid can flow without passing over the adsorbent material. These channels are disrupted by the passage of large bubbles of gas and then the bed is reformed, eliminating any channels which may have previously been formed. The reduction or elimination of channels in the bed of adsorbent material increases the interaction between the adsorbent material and the contaminated water being treated. In principle, any gas can be provided, but air is most conveniently provided. The addition of additional gas may be continuous or intermittent. In practice, it is sufficient to provide additional gas to a bed of adsorbent material around 2-3 times per week for a few minutes (dependent on the air or gas flow rate—the higher the air or gas flow rate the shorter the time required), although this can be done more regularly and/or for a different length of time as required. The addition of additional gas may at least partially fluidise areas of the bed of adsorbent material. The addition of gas also has the benefit of removing fine solids from the system, either particles which may have entered the treatment zone in the effluent or fines which may result from the breakdown of any adsorbent material used in the system. It should be noted that during the sparging of gas into the system the liquid flow can continue.

The modular water treatment unit may further comprise a first end wall and a second end wall. Said walls are distinct from the ribs and are operable to close the otherwise open ends of the container.

The modular water treatment unit may further comprise a mesh configured to prevent the loss of solid materials (e.g. conductive adsorbent materials) from the treatment volume while permitting flow of fluids. The mesh may be provided at the bottom of the ribs such that contaminated water provided via openings in the base portion of the ribs can pass through the mesh and such that any conductive adsorbent material within the unit is prevented from falling down through the openings. As such, the mesh comprises openings which are sized to prevent the conductive adsorbent material from passing through. Mesh may be provided above a bed of conductive adsorbent material to prevent it from being removed from the system by the flow of water being treated. Other support systems can also be alternatively or additionally used to prevent the escape of adsorbent material through the openings in the ribs, for example the use of appropriately sized gravel and sand can achieve this function. This also has the benefit that it helps to spread the bubbles from the ribs across the width of the treatment zones preventing the channelling of the injected gas bubbles through the bed of particles. A perforated plate may additionally or alternatively be used to prevent loss of solid materials.

A third aspect of the invention relates to a water treatment system comprising a tank with an inlet for supplying contaminated water, one or more treatment units according to the first aspect of the invention; said modular treatment units comprising one or more electrodes; and an electricity supply operably connectable to the electrodes. The modular treatment units may be located in the tank. In operation, the contaminated water enters the tank, where it is stored prior to entering the one or more treatment volumes.

The water treatment system may further comprise conductive, adsorbent material located in at least one of the modular water treatment units. Any conducting adsorbent material may be used. The adsorbent may be particulate or in the form of flakes. Such particles provide large surface areas for contaminant species to adsorb to, in addition the electrical current may pass through the particles, thereby enhancing the effectiveness of the electrochemical treatment by concentrating the contaminant species in a location where the current also passes.

The conductive, adsorbent material may comprise intercalated graphitic particles or flakes. Such particles or flakes are known to be particularly effective in continuous adsorption-regeneration systems. As an additional benefit, they do not form toxic by-products during use. An example of such a material is NYEX™ provided by Arvia Technology Limited, UK, although any conducting material that is capable of adsorption may be used.

The water treatment system may further comprise a treated water extractor configured to remove treated water from the or each water treatment unit. The extractor may comprise a pumped outlet to actively remove treated water, or a weir to passively remove treatment water as it reaches a set height within the container.

The water treatment system may comprise at least two modular treatment units arranged in parallel. In other words, the modular treatment units have a common supply.

The water treatment system may comprise at least two modular treatment units arranged in series. In other words, the output of a first modular treatment unit is used as the input to a second modular treatment unit, and so on. This may allow for the staged treatment of different contaminants or levels of contaminants that require different treatment conditions, such as current density or residence time.

The water treatment system may comprise treatment units arranged in series and in parallel. For example, there may be provided four units arranged in two groups comprising two units in series and the two groups are provided in parallel.

The or each modular unit may have an open top and at least a portion of said open top is positioned lower than the top of the tank. In such embodiments, an overflow may be provided for the water in the tank by allowing water to come over the top of the container wall. The difference in level of water may be provided by the removal of water from the units.

The water treatment system may further comprise an air supply configured to supply air to the or each treatment volume. As mentioned, during electrochemical treatment, hydrogen (and other) gases are produced which can form a coat of bubbles on the surface of items in the container. Counterintuitively, providing additional gas, usually air, to the treatment volume assists the removal of said gas bubbles. This is particularly advantageous in embodiments using conductive, adsorbent materials as the high surface area of such materials means that they accumulate hydrogen and other gases, which reduces their contact with the water and hence their effectiveness, as well as causing a reduction in flow. Compaction of the conductive, adsorbent materials is also reduced by this method, whereas simple vibration of the bed to remove the bubbles would result in compaction of the bed and therefore increase the resistance to flow of water to be treated.

Air supply to the or each treatment volume may be via hollow ribs. This reduces or removes the need to provide additional equipment for the supply of air. Alternatively the air may be sparged to the outside of the module, usually underneath the module, and the water flow can draw the air into the ribs where it is distributed into the bed.

Air supply to the or each treatment volume may be via a bubbler. A dedicated bubbler may allow more effective distribution of the air to the treatment volume by separation from the system for the provision of water to the treatment volume. A single air supply may be configured to selectively provide air to each unit as required. Since it is not necessary to supply additional air to each unit simultaneously, a single air supply may be used to supply air to each unit in the system sequentially.

A fourth aspect of the invention relates to a method of constructing a modular water treatment unit for a water treatment system, the method comprising the steps of a) arranging at least two ribs such that they form at least a portion of a container; b) positioning at least one membrane between adjacent ribs; and mutually affixing opposing faces of adjacent ribs and/or affixing opposing faces of adjacent ribs to the membrane disposed therebetween. The modular nature of the water treatment unit permits a simple construction method, which is simply adaptable to produce units of any desired size. The affixing may comprise gluing, solvent cementing or welding, or clamping of the ribs.

The method may further comprise providing at least two electrodes at least partially within the container. Two electrodes are required to set up the electrical circuit required to electrochemically treat water held in the container. More electrodes may be used. The electrodes are in electrical communication with a bed of conductive adsorbent material within the unit.

The ribs may comprise a recess to accommodate the at least one separator, which may be a membrane. The recess may be added to the or each rib by altering the shape of the ribs or by producing the ribs (e.g. by extrusion) in the desired shape.

The method may further comprise drilling or otherwise providing holes in the ribs to permit fluid communication. The holes may be through-holes (i.e. passing directly through the ribs from one side to the other. If the ribs are hollow, the holes may be off-set to permit flow through the rib. Drilling holes may be achieved by any suitable method.

Affixing may be achieved by adhesives, solvent cementing and/or welding. Adhesives and welding are methods which may be used to provide a water-tight seal between the ribs and do not interfere with the fit of the ribs as they do not introduce any elements which may stand proud of the ribs' surfaces, unlike, for example bolt heads, which may prevent secure and/or water-tight connection between adjacent ribs. Countersunk fixings (e.g. screws) may be used as an alternative or additional fixing. The ribs may be clamped together by internal or external members.

The method may further comprise positioning a bubbler within the container. The bubbler may be used to supply air to the treatment volume in order to effect removal of hydrogen and prevent compaction of any conductive, adsorbent material.

A fifth aspect of the invention relates to a method of operating a water treatment unit comprising the steps of: a) feeding contaminated water to a tank containing a container, said container comprising at least two ribs which retain a separator therebetween, the container at least partially housing at least two electrodes; b) passing the contaminated water through the container to a treatment volume defined by the container; c) passing the contaminated water through the treatment volume; d) passing electric current through the at least two electrodes such that the contaminated water within the treatment volume is converted to a treated water; and e) removing the treated water from the treatment volume.

The treatment volume may house a conductive, adsorbent material. The conductive, adsorbent material may comprise intercalated graphitic particles. The conductive, adsorbent material may comprise NYEX™, as supplied by Arvia Technology Limited, GB or any other conducting material that is capable of adsorption may be used.

The method may further comprise the step of passing air through the conductive, adsorbent material for a period at intervals. This removes hydrogen and other gases that accumulates during electrochemical treatment of water from the conductive, adsorbent material. This only needs to be performed periodically as hydrogen and other gases take time to accumulate on the surface of the conductive, adsorbent material.

The water level in the tank may be maintained at a higher level than the water level in the container. The difference in water levels provides a pressure differential that drives water into the container from the tank. This difference in water-levels may be maintained or adjusted by modifying the rates at which water enters the tank and/or leaves the container. It should be appreciated that the using this modular approach means that several modules can be placed into one larger tank. The water level in this tank is maintained by simple flow into the tank. This water will then flow through the modules and out through the outlets. Adjustable outlet weirs can be used to ensure equal flow through each unit, and maintaining this equal differential pressure between the modules will keep the flow uniform.

The container and the electrodes may comprise part of the modular water treatment unit of the first aspect of the invention.

The tank, container and the electrodes may comprise part of the water treatment system of the third aspect of the invention. Indeed, the features of any aspect of the present invention described herein may be combined with the features of any other aspect of the present invention described herein, except where such features are mutually exclusive. As such, all combinations of subject matter are expressly considered and contemplated.

It should be appreciated that this method of construction provides a very simple method of providing both standard and non-standard modules. No machining is required and the manufacturing tolerances are low. This minimises the cost of each module. By keeping the modules small (only small number of cells in each module gives a low voltage), handling is easy, making maintenance simple and there are minimal health and safety issues. Disconnecting one module will allow it to be removed from the outer tank without stopping treatment in the other modules. Minimal monitoring is required as there may be only one pipe control flow into the outer tank and treatment through a module can be prevented by merely closing the outlet vale.

### DESCRIPTION OF FIGURES

Embodiments of the invention will now be described, by way of example only, with reference to the accompanying schematic drawings, in which:

FIG. 1 shows a rib according the first aspect of the invention;

FIG. 2 shows a unit comprising 6 ribs as depicted in FIG. 1, a first end wall, a second end wall and a separator;

FIG. 3 shows a schematic of a system comprising unit and a tank;

FIG. 4 shows a schematic of a system comprising three units arranged in series;

FIG. 5 shows a schematic of a system comprising three units arranged in parallel;

FIG. 6A shows a cross section of recessed ribs and a separator prior to affixing;

FIG. 6B shows a cross section of recessed ribs and a separator in the assembled state;

FIG. 7 shows a cross section of an alternative recessed rib and a separator;

FIG. 8 is an exemplary schematic of a cross section of the system; and

FIG. 9 is a plan-view schematic of the system showing an exemplary air supply means.

### DETAILED DESCRIPTION

Specific embodiments of the present invention will now be described, by way of example only, with reference to the accompanying drawings briefly described above.

The modular water treatment unit comprises a combination of a plurality of ribs and at least one separator, preferably a membrane. The ribs are the structural component, being arranged to form a container defining a treatment volume, with the one or more separators acting to divide the treatment volume into compartments and to electrically insulate electrodes which are positioned within the treatment volume.

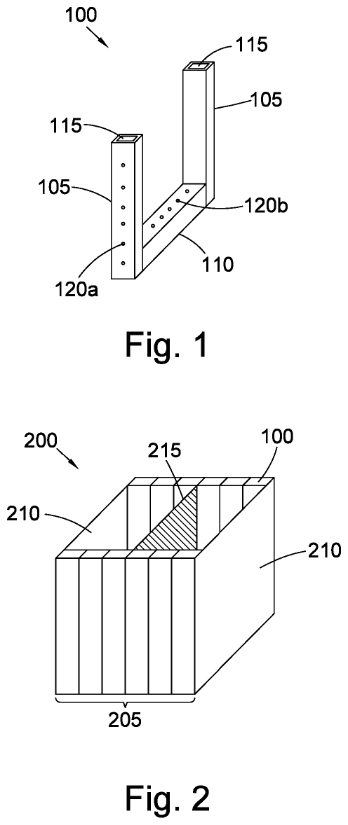

One embodiment of a rib 100 is shown in FIG. 1. The rib 100 is U-shaped, with the upright sections 105 being mutually parallel and perpendicular to the base section 110. Although depicted as three sections, the upright sections 105 and base section 110 are preferably formed from a single piece, which may be achieved by providing two 90° bends in a length of tubing. Of course, any other arrangement in which the three sections form a U-shape, or similar, may be used for this embodiment on the condition that, when multiple ribs are aligned, they form a container (for example, the sections may take the shape of three sides of a trapezium). Although not depicted, the tubing may be formed such that it forms a ring, namely that the tubing loops back on itself to form a closed structure.

The rib 100 is formed from plastic box section, which is hollow with optional openings 115 at each end. The rib 100 may be extruded with the angles between the upright 105 and base 110 sections being formed later, or the angles may be formed during the extrusion process. If manufactured in different sections then the join can be at an angle of 45° which will allow a hollow interior to run throughout the rib, although it will be appreciated that other angles are also suitable. Hydraulic connection can also be achieved in alternative ways.

The ribs 100 may be formed to any suitable size depending on the size of the container (and treatment volume) required for their intended application. The ribs are preferably sufficiently rigid to not require any additional bracing or support, although bracing or support may be provided where required.

Rib 100 is provided with a series of holes 120. There are inlet holes 120a located on the sides of the uprights 105 which will form the exterior surface of the container and treatment volume facing holes 120b on the upper face of base section 110. This arrangement of holes 120 allows for the flow of water into the container via the internal volume of the ribs 100, the flow being driven by maintenance of a higher water level outside the container than inside the container. The rate of flow may be controlled through design of the holes during construction (i.e. larger holes allow a higher flow rate) and by monitoring and control of the relative water levels inside and outside the container. In some embodiments, holes 120a are not provided and the liquid to be treated is provided via the openings 115 or other suitably located openings. In this embodiment no external tank is required as the hollow ribs provide a path for the liquid flow and distribution. In an embodiment additional holes can be in the exterior of the base section 110 allowing direct flow of liquid from the outside of the tank through holes 120b.

In certain embodiments, not depicted, the openings 115 may be provided with caps and/or connections for an air and/or liquid supply. Once assembled into the container, the supply of pressurized air to the internal volume of the ribs 100 via the openings 115 will result in air exiting the ribs 100 via the treatment volume facing holes 120b. This air will agitate any conductive adsorbent material, thereby removing any hydrogen that is bound to the surface of the material. In another embodiment the air can be introduced underneath the rib 100 where the additional holes allow air to pass through the holes into rib 100. The air then escapes through the holes 120b in rib 100 and pass up through the bed.

The ribs 100 are assembled into a modular water treatment unit 200, as shown in FIG. 2. Holes 120 and openings 115 have been omitted from FIG. 2 for clarity. A series of six ribs 100 have been arranged to form a container 205. Although six ribs 100 have been used in this example, it will be understood that substantially any number of ribs 100 may be used to obtain a container 205 of the desired length. Adjacent ribs 100 may mutually fixed by adhesive, although any other suitable fixing method (such as welding) may be used. A gasket may be provided between ribs. The gasket may be the membrane or a separate material.

End walls 210 have been provided to enclose the treatment volume defined by the container 205. The end walls 210 are made of plastic and attached by the same fixing method used for the walls, although, again, any suitable attachment method may be used. Plastic end walls ensure that the entirety of the container 205 is electrically insulting. Of course, any other suitable material may be used. This allows multiple units 200 to be used in close proximity in a single tank without interference. In alternative embodiments, the end walls 210 may be comprised partially, or entirely, of conductive material (e.g. metal, carbon) and act as the electrodes. A design can also be used where two (or more) modules could be linked together with a conducting end plate between the modules acting as an electrode for both modules.

A separator 215 is located between the third and fourth ribs 100, dividing the treatment volume into two compartments. The edges of the membrane 215 are gripped between the faces of the third and fourth ribs 100, thereby being held in place. Again, it will be appreciated that there may be more than one separator in the unit.

Once assembled into a water treatment system, the compartments will contain conductive adsorbent material and a suitable number of electrodes or current feeders provided. The membrane 215 prevents short circuiting through the adsorbent material, while allowing conduction through the movement of ions. The conducting adsorbent material acts as a bi-polar electrode within a multi-cell module, each cell being defined by two membranes and the ribs located between them with the exception of terminal cells which are defined by a membrane, an end wall, and the ribs located between them.

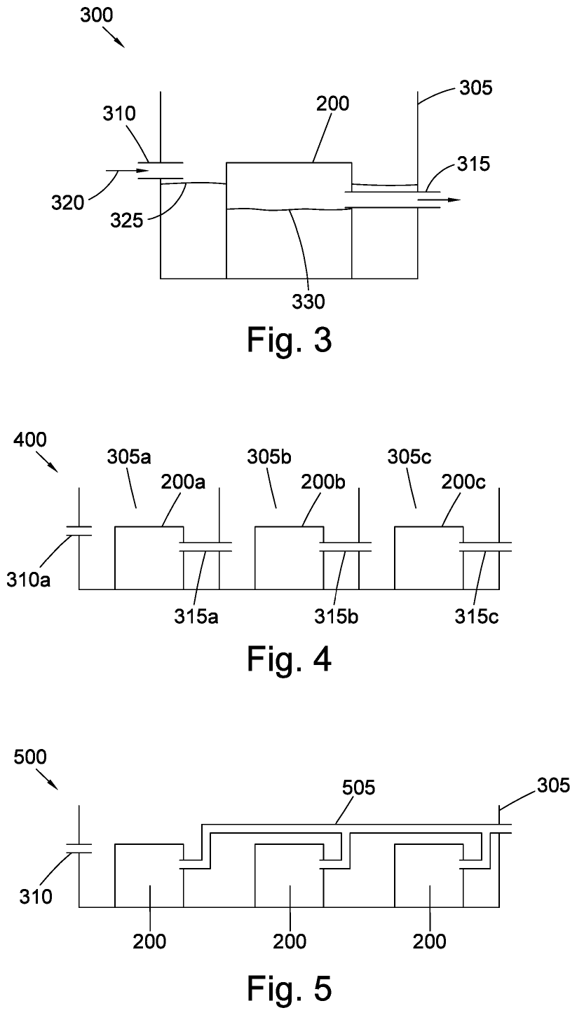

FIG. 3 shows a schematic of a water treatment system 300 comprising a tank 305 comprising an inlet 310 and a modular water treatment unit 200 with a treated water extract 315 positioned within the tank 305. For clarity, the electrodes and electricity supply have been omitted from this schematic.

In use, contaminated water 320 is supplied to the tank 305, which is filled to a first level 325. The water flows into the unit 200, preferably via the holes 120 in the ribs, where it is electrochemically treated in the treatment volume by the application of an electric current to the electrodes, the organic contaminants being destroyed by known processes. Treated water accumulates in the container 200 until it reaches a second level 330, at which point the treated water is removed from the container 200 via treated water extract 315. The extract 315 may be of any suitable form, for example, a horizontal pipe with a float valve or a vertical pipe, the walls of which form a weir. It will be appreciated that a water extract may also be referred to as a water outlet.

The rate of flow through the holes into the container is controlled by the relative heights of the first level 325 and second level 330. To an extent, this is pre-set by the physical layout of the inlet 310 and the extract 315, but the flow rate may still be modified through the control of the contaminated water flow 320 to adjust the first level 325. Accordingly, the system 300 may be provided with sensors, flow control means and/or a controller.

In this embodiment, the open top of the unit 200 lies below the top of the tank 305. In ordinary use, the first level 325 of water in the tank lies below the top of the unit 200 such that the water must enter the unit 200 through the holes in a controlled rate. However, under extraordinary conditions where the volume of water entering the tank 305 greatly exceeds the volume of water leaving the tank 305 the first level 325 will rise, risking flooding of the location in which the water treatment system 300 is located. This embodiment prevents this scenario as the unit 200 acts as overflow relief. When the height of the first level 325 exceeds the height of the unit 200, the excess water enters the unit 200 by flowing over the top. This prevents further rise in the first level 325 and escape of water from the tank 300.

FIG. 4 shows a schematic of a water treatment system 400 in which three units 200 are arranged in series, each unit 200 being in a segregated tank 305 (although it should be appreciated that there could be more than one unit 200 in each segregated tank). The extract 315a of the first unit 200a forming the feed for the tank 305b in which the second unit 200b resides, the extract 315b of the second unit 200b forming the feed for the tank 305c in which the third unit 200c resides. Any number of tanks 305 and units 200 may be used, as determined by the requirements of the system. The treatment of the water by sequential units 200 is highly effective at removing contaminants as the water must pass through multiple units 200.

Flow is maintained in the series of units of FIG. 4 by the relative heights of the inputs and extracts for each tank 305 and unit 200 to maintain a pressure differential across the walls of each unit 200. In other words, the extract is at a lower level for each subsequent unit, allowing the water to flow by gravity. In an alternative embodiment, the flow is maintained by pumps, requiring additional power and apparatus, but removing physical restraints required by the system.

FIG. 5 shows a schematic of a water treatment system 500 in which three units 200 are arranged in parallel. There is a single inlet 310 feeds contaminated water into a common tank 305 in which all three units 200 are located. Treated water from the units 200 is collected by a common extract system 505. The treatment of water by multiple units 200 operating in parallel allows for the rapid treatment of large volumes of water.

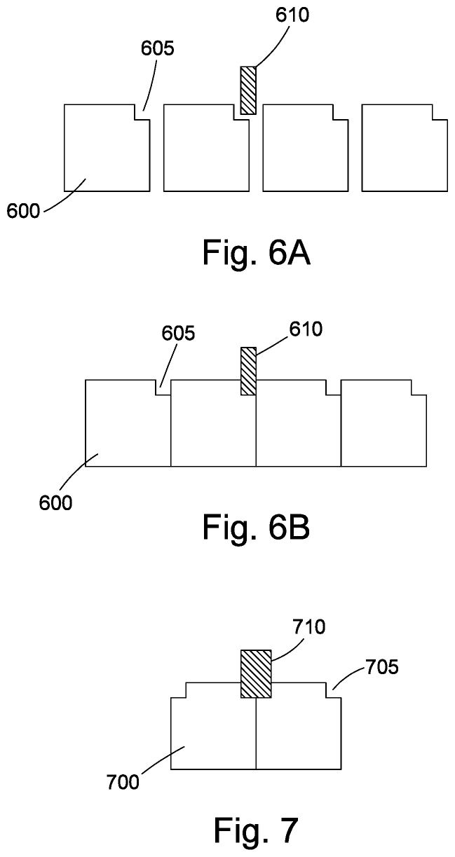

FIG. 6A shows a cross section of recessed ribs and a membrane prior to affixing. Each rib 600 contains a recess 605 configured to hold a membrane 610. The depth and width of each recess 605 is sufficient to accommodate the width of the membrane 610 while ensuring that there is a large enough contact area between the membrane 610 and the rib 600 to securely hold the membrane 610 when it is assembled.

FIG. 6B shows a cross section of recessed ribs and a separator in the assembled state. Adjacent ribs 600 are mutually affixed and the membrane 610 is held securely in the recess 605 of the second rib so that it frictionally engages the second and third ribs. In certain embodiments, adhesives, solvent cementing and/or welding may also be used to secure the membrane 610 into the recess 605.

The recess 605 may be formed during the extrusion of the rib 600. Alternatively, the recess 605 may be added to the rib 600 by altering its shape. This may be achieved by any suitable method, such as routing a groove or deforming the shape of a hollow rib or by adding a piece of plastic to the box section. There may be a protrusion which is adjacent the recess when assembled which extends towards the recess to hold the membrane even more securely in place.

FIG. 7 shows a cross section of an alternative recessed rib and a separator. In this embodiment, each rib 700 contains multiple recesses 705 configured to house a portion of the width of the membrane 710 when the ribs 700 are in the assembled state. In other words, the contiguous recesses 705 of adjacent ribs 700 form a volume sufficient to house the membrane 710.

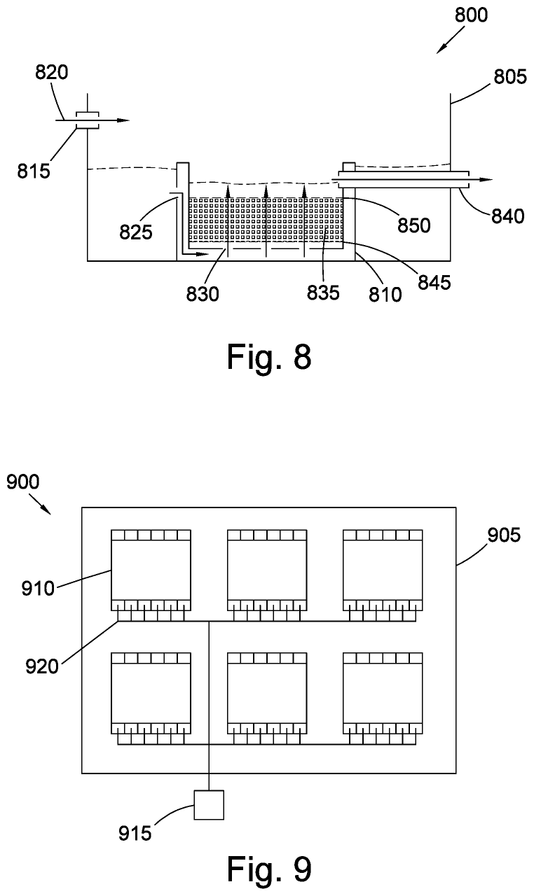

FIG. 8 is an exemplary schematic of a cross section of the system, showing the flow of the water through the system. In this example the system 800 comprises a tank 805 holding a water treatment unit 810. Contaminated water enters the tank 805 through inlet 815 as flow 820. Contaminated water flows from the tank 805 into the interior volume of the ribs of the unit 810 through hole 825 and then into the treatment volume of the unit through holes 830. The contaminated water then flows through the bed of adsorbent material 835, as the water flows, a current is passed through the adsorbent bed by the electrodes (not shown), causing electrochemical treatment of the water by electrochemical destruction of the contaminants therein. The treated water accumulates above the adsorbent material 835, being taken off through treated water extract 840. The flow of water through the interior volume of the ribs and the adsorbent bed is ensured by the maintenance of a higher water level in the tank 805 than in the unit 810, the pressure of the head of water directing the flow. Loss of the adsorbent material is prevented through the use of a mesh 845 below the adsorbent material 835, preventing the material 835 falling into the ribs of the unit 805 through holes 830 and a mesh 850 above the material 835 preventing the material from becoming entrained in the flow of water and exiting through the treated water extract 840.

FIG. 9 is a plan-view schematic of the system showing an exemplary air supply means. The system 900 comprises a tank 905 containing six units 910 (of course, any number of units may be used) comprising multiple ribs 915. For clarity, the membranes, contaminated water inlet(s), holes and treated water extracts are omitted from the drawings for clarity. Each rib 915 is connected to an air supply 915 via pipes 920. Of course, not necessarily every rib 915 is connected to the air supply, merely sufficient ribs 915 to ensure adequate air is supplied to effectively remove adsorbed hydrogen or other gases from the adsorbent material. The air supply 915 provides air to the ribs 915, the interior volumes of which act as conduits to conduct the air to the base of the conductive, adsorbent material. The air then proceeds to flow through the material, agitating it and removing hydrogen and other gases adsorbed to its surface. Alternatively, the pipes 920 may feed directly into the units 910, bypassing the ribs; in such embodiments, a bubbler can be connected to the pipes to ensure efficient provision of air to the material. Alternatively the air can be introduced underneath the ribs to flow through the ribs and into the bed.

The electrochemical process produces hydrogen at a gradual rate. As a result, the removal of the trapped hydrogen or other gases (e.g. by the passing of air through the material) need only be performed periodically with most of the gases escaping through the bed through coalescence into larger bubbles. Accordingly, the air supply 915 may only provide air as and when required. Additionally, the pipes 920 and/or air supply 915 may be provided with valves and/or a controller configured to direct air to the units 910 in a sequential manner.

The present invention provides a highly flexible and configurable system which may be used in the treatment of contaminated water. The system is modular as it is constructed from ribs allowing the size of the units to be altered by altering the number of ribs used to form the unit. The ribs are preferably hollow to allow the structure of the units to also serve as flow conduits. Furthermore, since the ribs are able to trap separators therebetween, it is far easier to ensure a watertight seal between different compartments in the units whereas when a unitary tank is required to be divided into separate compartments, it is difficult and time-consuming to insert the separators and ensure that they do not leak. Since the separators are very thin, typically in the order of a few millimetres or less, it is very hard to provide a decent seal by attaching the separators to an inner wall of a conventional tank. In contrast, the present invention allows for the separators to be trapped between adjacent ribs which ensures a fast and reliable seal and which holds the separator in the units much more securely and robustly than previously achievable.

1. A modular water treatment unit for a water treatment system comprising:
two or more ribs arranged to form at least part of a container; and
one or more separators, said one or more separators disposed between adjacent ribs.

2. The modular water treatment unit of claim 1, wherein:
i. the ribs are hollow; and/or
ii. the ribs form a base and walls of the container; and/or
iii. the ribs are substantially u-shaped; and/or
iv. the ribs are configured to engage with adjacent ribs to form a fluid-tight seal.

3. The modular water treatment unit of claim 1, wherein:
i. the ribs comprise plastic; and/or
ii. the ribs include a recess to accommodate the one or more separators.

4. The modular water treatment unit of claim 1, wherein the ribs are configured to permit fluid communication into a treatment volume defined by the container, optionally wherein fluid communication into the treatment volume is via the internal volume of the ribs.

5. The modular water treatment unit of claim 4, wherein the ribs have through-holes permitting fluid communication into the treatment volume.

6. The modular water treatment unit of claim 1, additionally comprising:
i. a mesh configured to prevent solid material leaving a or the treatment volume of the container; and/or
ii. apparatus for the delivery of air to the treatment volume.

7. The modular water treatment unit of claim 1, wherein each separator is a membrane and/or is non-conductive.

8. The modular water treatment unit of claim 1, wherein the modular water treatment unit comprises at least two electrodes at least partially contained within the container, preferably wherein the electrodes are operably connected to a power supply.

9. The modular water treatment unit of claim 1, wherein the unit comprises:
i. conductive adsorbent material within the treatment volume; and/or
ii. a first end wall and a second end wall.

10. A water treatment system comprising:
a tank with an inlet for supplying contaminated water;
one or more modular water treatment units as defined in claim 1 located within the tank;
said modular water treatment units comprising one or more electrodes; and
an electricity supply operably connectable to the electrodes.

11. The water treatment system of claim 10, further comprising:
i. conductive, adsorbent material located in at least one of the modular water treatment units, optionally wherein the conductive, adsorbent material comprises intercalated graphitic particles; and/or
ii. a treated water extractor configured to remove treated water from the or each water treatment unit.

12. The water treatment system of claim 10 comprising:
i. at least two modular treatment units arranged in parallel; and/or
ii. at least two modular treatment units arranges in series.

13. The water treatment system of claim 11, wherein the or each modular unit has an open top and at least a portion of the top of the container is positioned lower than the top of the tank.

14. The water treatment system of claim 10, further comprising an air supply configured to supply air to the or each treatment volume, optionally wherein the air supply to the or each treatment volume is via the hollow ribs, optionally wherein the air supply to the or each treatment volume is via a bubbler.

15. A method of constructing a modular water treatment unit for a water treatment system, the method comprising the steps of:
a) arranging at least two ribs such that they form at least a portion of a container;
b) positioning at least one separator between adjacent ribs; and
c) mutually affixing opposing faces of adjacent ribs and/or affixing opposing faces of adjacent ribs to the separator disposed therebetween.

16. The method of claim 15, further comprising:
i. providing at least two electrodes at least partially within the container; and/or
ii. drilling holes in the ribs to permit fluid communication; and/or
iii. positioning a bubbler within the container.

17. The method of claim 15, wherein the ribs comprise a recess to accommodate the at least one separator.

18. The method of claim 15, wherein affixing is achieved by adhesives, solvent cementing and/or welding.

19. A method of operating a water treatment unit comprising the steps of:
a) feeding contaminated water to a tank containing a container, said container comprising at least two ribs which retain a separator therebetween, the container at least partially housing at least two electrodes;
b) passing the contaminated water through the container to a treatment volume defined by the container;
c) passing the contaminated water through the treatment volume;
d) passing electric current through the at least two electrodes such that the contaminated water within the treatment volume is converted to a treated water; and
e) removing the treated water from the treatment volume.

20. The method of claim 19, wherein the treatment volume houses a conductive adsorbent material, optionally wherein the conductive, adsorbent material comprises intercalated graphitic particles.

21. The method of claim 19, further comprising the step of passing air through the conductive, adsorbent material for a period at intervals.

22. The method of claim 19, wherein the water level in the tank is maintained at a higher level than the water level in the container.

23. The method of claim 19, wherein the container and the electrodes comprise part of the modular water treatment unit of claim 1.

24. The method of claim 19, wherein the tank, the container and the electrodes comprise part of the water treatment system of claim 10.

25. (canceled)
